(19) United States
(12) Patent Application Publication
(10) Pub. No.: US 2015/0107774 A1
(43) Pub. Date: Apr. 23, 2015

(54) APPARATUS FOR MANUFACTURING MEMBRANE ELECTRODE ASSEMBLY

(71) Applicants: Kia Motors Corporation, Seoul (KR); Hyundai Motor Company, Seoul (KR)

(72) Inventor: Hoon Hui LEE, Seoul (KR)

(73) Assignees: KIA MOTORS CORPORATION, Seoul (KR); HYUNDAI MOTOR COMPANY, Seoul (KR)

(21) Appl. No.: 14/104,983

(22) Filed: Dec. 12, 2013

(30) Foreign Application Priority Data
Oct. 18, 2013 (KR) 10-2013-0124289

(51) Int. Cl. B32B 41/00

(52) U.S. Cl. CPC B32B 41/00
USPC 156/352; 156/378

(57) ABSTRACT

An apparatus for manufacturing a membrane electrode assembly to selectively drive/stop by checking whether temperature control of transfer rolls is normal is provided. The apparatus includes transfer rolls, the temperature of which is controlled by a temperature control unit, to pass a transfer film on which a polymer electrolyte membrane and electrodes are formed therebetween in order to press the transfer film and to transfer the electrodes onto the polymer electrolyte membrane; a thermochromic pigment inserting device installed at a front end of the transfer rolls to coat the thermochromic pigment on the polymer electrolyte membrane; a color information acquiring unit installed at the rear side of the transfer rolls to acquire color change information of the thermochromic pigment; and a controller to check whether temperature control of the transfer rolls is normal from the color change information of the thermochromic pigment acquired by the color information acquiring unit.

### CROSS-REFERENCE TO RELATED APPLICATION

This application claims under 35 U.S.C. §119(a) the benefit of Korean Patent Application No. 10-2013-0124289 filed Oct. 18, 2013, the entire contents of which are incorporated herein by reference.

### BACKGROUND

(a) Technical Field

The present disclosure relates to an apparatus for manufacturing a membrane electrode assembly, and more particularly to an apparatus for manufacturing a membrane electrode assembly by checking whether the temperature of a transfer roll is properly controlled so as to automatically select a driving mode and a stopping mode.

(b) Background Art

A fuel cell is a kind of an electric generator that does not burn the chemical energy of fuel to convert the chemical energy into heat but rather into electric energy through an electro-chemical reaction within a stack. The fuel cell may supply electricity for commercial purpose and for a home, and may be also be applied to small size electric/electronic devices, portable devices, and to feeding of electric power to to start up a vehicle. A polymer electrolyte membrane fuel cell (PEMF) with the highest power density among fuel cells is commonly researched as an existing power supply for starting of a vehicle.

The PEMF includes a membrane electrode assembly (MEA) in which catalyst electrode membranes where electro-chemical reaction occurs are attached to both sides of a solid polymer electrolyte membrane, a gas diffusion layer (GDS) diffusing a reactive gas evenly and transferring generated electric energy, and a separator to move the reactive gas and coolant.

When stacks of a fuel cell are assembled with unit cells, a major component thereof which is a combination of a membrane electrode assembly and a gas diffusion layer is located. The membrane electrode assembly includes a catalyst electrode layer (that is, an anode and a cathode) containing a catalyst such that oxygen and hydrogen react with each other on both sides of the polymer electrolyte membrane and a gas diffusion layer and a gasket laminated on the outside thereof.

The separator is disposed to feed the reactive gas (hydrogen as a fuel and oxygen or air as an oxidizing agent) and to pass the coolant on the outside of the gas diffusion layer.

An assembly in which catalyst electrode membranes (an anode and a cathode) are attached to both sides of the polymer electrolyte membrane during the manufacturing is called a 3-layer membrane electrode assembly, an assembly in which a sub-gasket is further added is called a 5-layer membrane electrode assembly, and an assembly to which a gas diffusion layer laminated on the outside of the catalyst electrode membrane is added is called a 7-layer membrane electrode assembly.

One unit cell is completed when a separator, in which passages for a reactive gas and a coolant are formed, is laminated on the outside of the gas diffusion layer of the 7-layer membrane electrode assembly and a desired fuel cell stack is made by laminating these several unit cells.

There are several patents related to the method of manufacturing the membrane electrode assembly, such as Korean Patent Nos. 10-0969029 (Jul. 9, 2010) and 10-1080783 (Nov. 7, 2011) and Korean Patent Application Publication Nos. 10-2012-0117266 (Oct. 24, 2012) and 10-2012-0115637 (Oct. 19, 2012). Among these patent documents, there is known a method of manufacturing a 3-layer membrane electrode assembly, including forming a catalyst electrode membrane by coating catalyst slurry on the surface of a transfer film (a release film) and drying the same, laminating the transfer films, on which the catalyst electrode layers are formed respectively, on both sides of the polymer electrolyte membrane, transferring the catalyst electrode layers on both sides of the polymer electrolyte membrane, and removing the transfer film.

In addition, a continuous roll-to-roll apparatus for manufacturing 3-layer membrane electrode assemblies under a mass scale is applied. In this case, the catalyst electrode layers are bonded by pressing and transferring the catalyst electrode layers to both sides of the electrolyte membrane with heated transfer rolls.

FIG. 1 shows a roll-to-roll apparatus for manufacturing a 3-layer membrane electrode assembly which is an apparatus for automatically transferring an electrode to manufacture a membrane electrode assembly 4 by transferring catalyst electrode layers (a cathode and an anode) 3 onto both sides of an electrolyte membrane 1.

As illustrated in FIG. 1, the electrolyte membrane 1 fed from a membrane feeding roll 11 and transfer films 2 (films on which the catalyst electrode layers are formed in advance) fed from film feeding rolls 12 pass and are pressed between transfer rolls 13 temperature of which is controlled and then the catalyst electrode layers (hereinafter, referred to an ‘electrode’) 3 are transferred to both sides of the electrolyte membrane 1. After that, a protective film 5 is laminated on the 3-layer membrane electrode assembly 4 to which the electrodes 3 are bonded and rolled around a roll 15 to keep, while the transfer films 2 in which the electrodes 3 are transferred already are wound around separated rolls 14 and are separated from the membrane electrode assembly

The continuous apparatus for manufacturing a membrane electrode assembly further includes a temperature control unit (not shown) to control temperature of the transfer rolls 13 within a set temperature. If the temperature control unit does not control the temperature of the transfer roll within a proper temperature, inferior membrane electrode assemblies are manufactured. That is, if the transfer rolls are not controlled within a proper temperature range due to unstable control by or malfunction of the temperature control unit (especially, exceeding a set temperature), inferior products may be manufactured. In addition, a great deal of inferior products may be manufactured when this troubleshooting is not detected at the right time of the process due to continuous operation of the apparatus when continuously manufacturing the membrane electrode assemblies.

Since increased inferiority in mass production affects product prices as a result of being an important contributor to manufacturing cost, there is a need to reduce the possibility of inferiority in the manufacturing process. However, although a temperature sensor is installed in the apparatus such that the temperature sensor is properly associated with a heating device (simple turning on/off of the heating device by sensing temperature), the existing apparatus does include an auxiliary device to check temperature of the transfer rolls when the temperature sensor malfunctions.

Most of all, since the existing apparatus for manufacturing a membrane electrode assembly does not includes a system to monitor the temperature control state of the transfer rolls and to check on whether the temperature control has malfunctioned and to take prompt emergency measures if necessary, product inferiority increases and thus there is a need for reducing inferior products by detecting malfunctioning of the temperature control for the transfer rolls.

### SUMMARY OF THE DISCLOSURE

The present invention provides an apparatus for manufacturing a membrane electrode assembly by checking on whether temperature control of a transfer roll is malfunctioning to select a driving mode/a stopping mode.

More particularly, the present invention provides an apparatus for manufacturing a membrane electrode assembly including a system to monitor and check whether there is a malfunction of the temperature control in which temperature of the transfer roll exceeds a temperature limit during the process, so as to automatically select a driving mode/a stopping mode or to continue the manufacturing process by taking necessary follow-up measures. In accordance with an aspect of the present invention, there is provided apparatus for manufacturing a membrane electrode assembly, including: transfer rolls, the temperature of which is controlled by a temperature control unit, to pass a transfer film on which a polymer electrolyte membrane and electrodes are formed therebetween to press the transfer film and to transfer the electrodes onto the polymer electrolyte membrane; a thermochromic pigment inserting device installed at a front end of the transfer rolls to coat the thermochromic pigment on the polymer electrolyte membrane; a color information acquiring unit installed at the rear side of the transfer rolls to acquire color change information of the thermochromic pigment; and a controller to check whether temperature control of the transfer rolls is normal from the color change information of the thermochromic pigment acquired by the color information acquiring unit.

In an embodiment of the present invention, the thermochromic pigment inserting unit is provided such that the thermochromic pigment is coated at a lateral position of an electrode area on the polymer electrolyte membrane and to coat the thermochromic pigment along the polymer electrolyte membrane in a continuous line form or intermittently at predetermined intervals.

In another embodiment of the present invention, the apparatus may further include an alarm device driven by the controller, and the controller may be set to drive the alarm device when the controller determines that the temperature control of the transfer rolls in which the temperature of the transfer rolls exceeds a predetermined temperature range has malfunctioned from the color change information of the thermochromic pigment.

In still another embodiment of the present invention, the controller may be set to stop the apparatus when the temperature control of the transfer rolls in which the temperature of the transfer rolls exceeds a predetermined temperature range has malfunctioned from the color change information of the thermochromic pigment.

In yet another embodiment of the present invention, the color information acquiring unit may include a vision camera to photograph the thermochromic pigment passing between the transfer rolls and to transmit a photographed image of the thermochromic pigment to the controller, and the controller may check a color of the thermochromic pigment from the transmitted image from the vision camera and may determine whether the temperature control of the transfer rolls has malfunctioned.

In yet another embodiment of the present invention, the thermochromic pigment may be a thermochromic pigment color which changes to a predetermined color at a temperature exceeding an upper limit of the predetermined temperature of the transfer rolls, and the controller may determine the malfunctioned temperature control of the transfer rolls by checking whether the color of the thermochromic pigment changes to the predetermined color.

In yet another embodiment of the present invention, the thermochromic pigment may be a thermochromic pigment color of which changes to the predetermined color at temperature of ‘an upper limit +a’ that a margin ‘a’ is added to an upper limit of the setting temperature range of the transfer rolls, and the controller may determine the malfunctioned temperature control of the transfer rolls by checking whether the color of the thermochromic pigment changes to the predetermined color.

In yet another embodiment of the present invention, the temperature control unit may include a cooling device driven by the controller to cool the transfer rolls, and the controller may control the temperature of the transfer rolls within the predetermined temperature range by driving the cooling device under the acquired color change information of the thermochromic pigment when the transfer rolls are overheated beyond the predetermined temperature range of the transfer rolls.

In yet another embodiment of the present invention, the cooling device may include a cooling passage provided in the transfer rolls to allow a coolant to flow and a coolant feeding device driven to feed the coolant to the cooling passage according to a control signal from the controller.

Thus, since whether temperature control of the transfer rolls is automatically determined from color change of a thermochromic pigment, a malfunction can be promptly detected during the continuous process, and measures can be taken.

In addition, since the apparatus according to the present invention automatically selects a driving mode/a stopping mode (or a continuous driving mode by cooling the overtheated transfer rolls) when the temperature control has malfunctioned, inferior products caused by the malfunction of the temperature control for the transfer rolls can be reduced. Especially, since a great many of the products can be prevented from being inferior during continuous manufacturing, increased manufacturing cost due to such inferior products can be solved.

Moreover, since the apparatus according to the present invention further includes a safety device to detect a malfunctioned temperature control of the transfer rolls using a thermochromic pigment in addition to a temperature sensor detecting temperature of the transfer rolls, inferior products can be minimized even when the temperature sensor has malfunctioned and the temperature control unit has malfunctioned.

Furthermore, deviation of product performance of the product membrane electrode assemblies can be managed and productivity of the final products improved.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating an existing roll-to-roll apparatus for manufacturing a 3-layer membrane electrode assembly;

FIG. 2 is a schematic diagram illustrating an apparatus for manufacturing a membrane electrode assembly according to an embodiment of the present invention;

FIG. 3 is a plan view illustrating a thermochromic pigment being introduced into an electrolyte membrane according to the embodiment of the present invention;

FIG. 4 is a view illustrating several examples of coating a thermochromic pigment according to the embodiment of the present invention;

FIG. 5 is a schematic diagram illustrating an apparatus for manufacturing a membrane electrode assembly according to another embodiment of the present invention; and

FIG. 6 is a schematic view illustrating an example of a cooling device employed in the apparatus for manufacturing a membrane electrode assembly according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The present invention provides an apparatus for manufacturing a membrane electrode assembly by checking whether the temperature control of a transfer roll has malfunctioned so as to select a driving mode/a stopping mode.

More particularly, the present invention provides an apparatus for manufacturing a membrane electrode assembly including a system to monitor and check whether there is a malfunction of the temperature control such that temperature of the transfer roll exceeds a temperature limit during the process, and thereby to automatically select a driving mode/a stopping mode or to continue the manufacturing process by taking necessary follow-up measures for preventing the membrane electrode assembly from being inferior when the temperature of the transfer roll exceeds a predetermined temperature, that is, a proper temperature range.

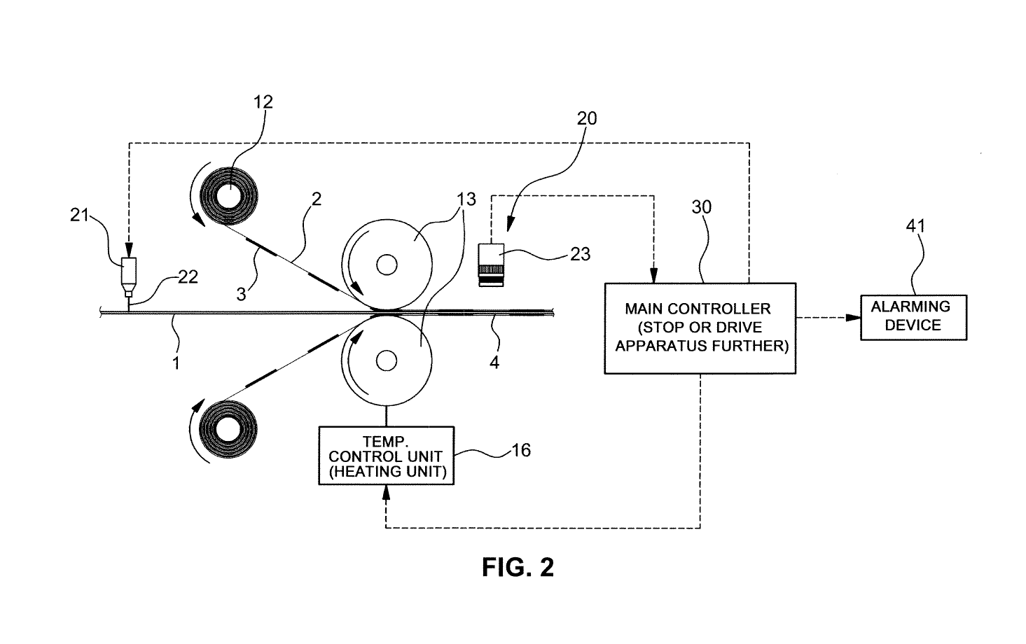

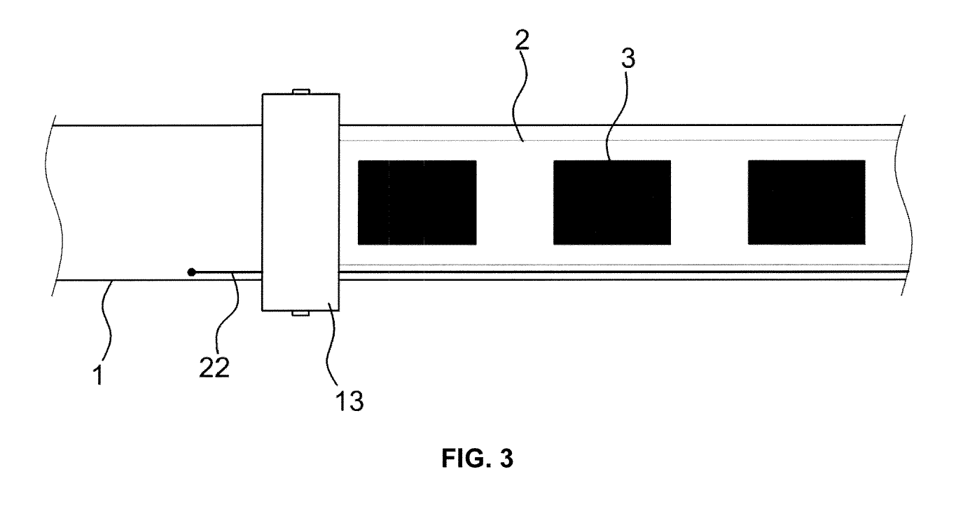

FIG. 2 is a schematic diagram illustrating an apparatus for manufacturing a membrane electrode assembly according to an embodiment of the present invention and FIG. 3 is a plan view illustrating a thermochromic pigment being introduced into an electrolyte membrane according to the embodiment of the present invention.

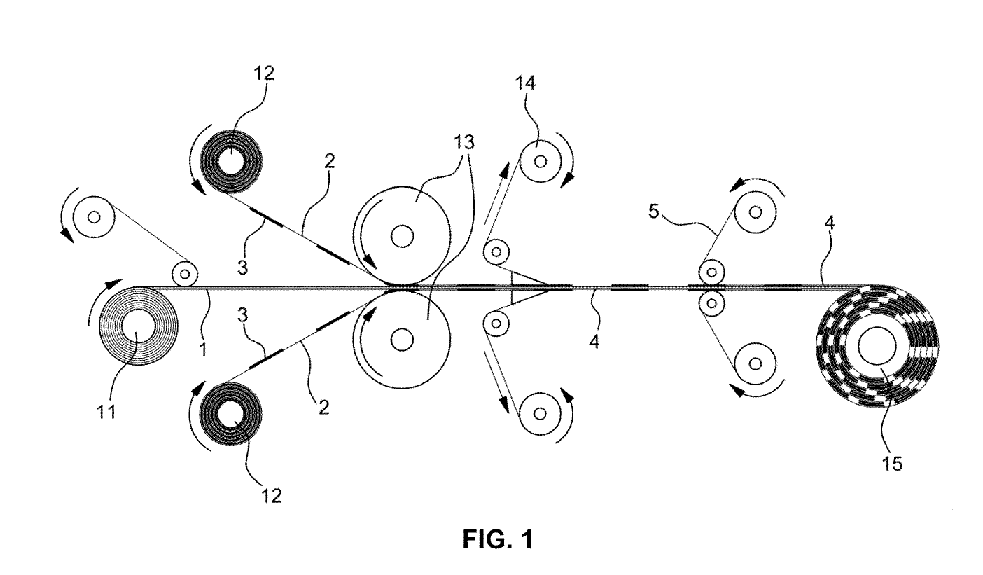

An apparatus for manufacturing a membrane electrode assembly according to an embodiment of the present invention is an improvement over the existing continuous roll-to-toll apparatus for manufacturing a membrane electrode assembly as illustrated in FIG. 1, and further includes, as illustrated in FIG. 2, a system 20 for inserting a thermochromic pigment 22 into a polymer electrolyte membrane 1 before passing transfer rolls 13 and for checking whether color change of the thermochromic pigment indicates that temperature control of the transfer rolls has malfunctioned. That is, the apparatus according to the embodiment of the present invention does not differ from the apparatus as illustrated in FIG. 1 in view of passing and pressing the polymer electrolyte membrane 1 fed from a film feeding roll 11 (See FIG. 1) and transfering films (films on which electrodes are formed in advance respectively) 2 fed from film feeding rolls 12 between transfer rolls 13, the temperature of which is controlled to transfer electrodes 3 onto both sides of the polymer electrolyte membrane 1.

However, the apparatus for manufacturing a membrane electrode assembly according to the embodiment of the present invention includes a monitoring system 20 to monitor the temperature control status of the transfer rolls 13 using a thermochromic pigment 22 in addition to the apparatus illustrated in FIG. 1. The monitoring system 20 includes a thermochromic pigment inserting unit 21 to insert the thermochromic pigment 22 and a color information acquiring unit 23 to acquire color change information of the thermochromic pigment 22.

FIG. 2 shows the transfer rolls 13, a predetermed heating temperature of which is controlled by the temperature control unit 16, the polymer electrolyte membrane 1 fed from a film feeding roll (not shown in FIG. 2) to the transfer rolls 13, the transfer films 2 fed from the film feeding rolls 12 to the transfer rolls 13, and the monitoring system 20, wherein the transfer films 2 fed to the transfer rolls 13 include electrodes 3 to be bonded to the polymer electrolyte membrane 1 on the surfaces thereof in advance.

The transfer films 2, on which the electrodes (a cathode and an anode) are formed on the surfaces respectively, are laminated on both sides of the polymer electrolyte membrane 1 fed to the transfer rolls 13, and the laminated polymer electrolyte membrane 1 is pressed while passing between the transfer rolls 13, the temperature of which is controlled by the temperature control unit 16 to transfer the electrodes 3 onto both sides of the polymer electrolyte membrane 1.

The transfer films, the electrode of which are transferred as described above, are separated from the membrane electrode assembly for removal.

The temperature control unit 16 may include a heating device to heat the transfer rolls 13 within a predetermined temperature range, temperature sensors (not shown) to detect the temperature of the transfer rolls 13, and a control unit to control the heating device based on a detected temperature by the temperature sensors. The control unit controls the heating device based on the temperature of the transfer rolls detected by the temperature sensors by turning on/off the heating device.

That is, when the temperature of the transfer rolls detected by the temperature sensors exceeds the predetermined temperature range, the control unit of the temperature control unit provided in the transfer rolls of the apparatus for manufacturing a membrane electrode assembly according to this embodiment of the present invention turns off the heating device to control the temperature of the transfer rolls properly.

The control unit may be a main control unit as described later, or a separated control unit for a temperature control unit.

The monitoring system 20 inserts the thermochromic pigment 22 into the polymer electrolyte membrane 1 before the transferring and checks the color change of the thermochromic pigment to monitor whether the transfer rolls 13 are controlled and driven within the predetermined temperature range.

To this end, the thermochromic pigment inserting unit 21 of the monitoring system 20 is installed at the front end of the transfer rolls 13 and inserts the polymer electrolyte membrane 1 before passing between the transfer rolls 13, that is, inserts the thermochromic pigment 22 on a surface of the electrolyte membrane that enters between the transfer rolls 13.

The thermochromic pigment inserting unit 21 may be controlled by a main control unit 30 as described later.

Referring to FIG. 3, the thermochromic pigment 22 is inserted at the front end of the transfer rolls 13, while the thermochromic pigment 22 is coated to be positioned at the lateral side of the electrodes 3 transferred from the polymer electrolyte membrane 1 at the rear side of the passed transfer rolls 13.

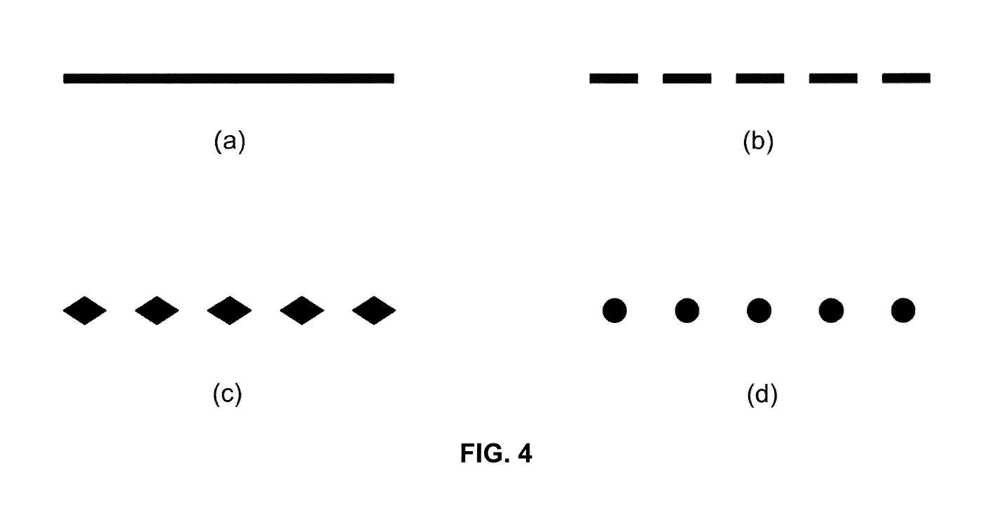

In this case, the thermochromic pigment 22 may be coated linearform a as described in FIG. 4, in the dashed line form b, or in a form c or d such as in the diamond dotted line or in the dotted line.

Moreover the thermochromic pigment 22 may be coated on the outside of an area on the polymer electrolyte membrane 1 where the transfer films 2 are laminated (See FIG. 3) by taking the lamination of the transfer films 2 on which the electrodes (a cathode and an anode) 3 are formed on both sides of the polymer electrolyte membrane 1 before passing between the transfer rolls 13. In this case, since the transfer films 2 do not cover the thermochromic pigment 22 after the lamination, the color change of the thermochromic pigment 22 on the outside of the transfer films 2 at the rear side of the transfer rolls 13 can be checked.

In general, since the width of the electrolyte membrane is greater than the width of the transfer films, it is possible to coat the thermochromic pigment on the outer margin of the area where the transfer films are laminated.

If the transfer films, on which the electrodes are formed and which are laminated on both sides of the electrolyte membrane, were transparent films, the thermochromic pigment may be coated on the lateral position near the electrodes except the area on which the electrodes are transferred on the electrolyte membrane.

The thermochromic pigment (also called a temperature-measuring pigment or a thermocolor) has color changing to a predetermined temperature according to temperature. When the thermochromic pigment 22 is coated on the front end of the transfer rolls 13 and the electrolyte membrane 1 passes between the transfer rolls, the color of the thermochromic pigment changes according to the temperature of the transfer rolls 13 controlled by the temperature control unit 16.

At this time, if the color of the thermochromic pigment passed between the transfer rolls 13 were the predetermined color appearing within the setting temperature range of the transfer rolls, the temperature of the transfer rolls can be checked as being normally controlled by the temperature control unit 16.

On the contrary, if the color of the thermochromic pigment were not the predetermined color (at the rear side of the transfer rolls) after passing between the transfer rolls 13, malfunction of the temperature control for the transfer rolls can be checked.

For example, if the color of the thermochromic pigment were changed into the color appearing when the temperature of the transfer rolls exceeds the predetermined temperature range, the overheating state of the transfer rolls exceeding the predetermined temperature range can be checked.

As such, if the color of the thermochromic pigment after passing between the transfer rolls (the color of the thermochromic pigment at the rear side of the transfer rolls) were checked, it is possible to check whether the temperature of the transfer rolls is controlled within the normal range, whether the temperature control unit is driven normally and whether the temperature control of the transfer rolls has malfunctioned.

The color of the thermochromic pigment appearing at the rear side of the transfer rolls becomes an indicator to check whether the temperature control of the transfer rolls is normal. The color change of the thermochromic pigment allows to check whether the temperature control of the transfer rolls has malfunctioned, to turn an alarming device on if necessary and to stop the apparatus for manufacturing a membrane electrode assembly according to this embodiment of the present invention, or to drive the apparatus further if the temperature control is normal. Thus, in this embodiment, since a safety device for reducing a series of inferior membrane electrode assemblies using the thermochromic pigment may be provided and the manufacturing process for the membrane electrode assembly can be controlled by checking whether the temperature sensor and/or the temperature control unit has malfunctioned, inferiority can be reduced, manufacturing costs can be prevented from increasing, and productivity of the membrane electrode assembly can be improved by managing performance deviation of the membrane electrode assembly (the temperature change during the manufacturing process affects the performance of the membrane electrode assembly) to be uniform.

In this embodiment, the thermochromic pigment may be selected properly according to temperature conditions of the transfer rolls, and a thermochromic pigment, the temperature of which may change to a predetermined color at a temperature exceeding an upper limit of the setting temperature range of the transfer rolls, should be selected.

In this case, a thermochromic pigment which has the upper limit (for example, 130 degrees in Celsius) with a margin a (for example, 10 degrees in Celsius) such that the color change is completed at the temperature of at least the ‘upper limit+α’ (for example, 130+10=140 degrees in Celsius) is preferably selected.

In addition, a thermochromic pigment having a color such as an achromatic color (black) or a chromatic color (red, orange color, purple, green, yellow, etc.) may be selected. A known thermochromic pigment capable of indicating whether temperature control of the transfer rolls is normal before or after the color change regardless of the color change according to the temperature is reversible or irreversible, may be selected.

The color information acquiring unit 23 which is provided to acquire color change information of the thermochromic pigment 22 on the polymer electrolyte membrane 1 passing between the transfer rolls 13, is installed at the rear side of the transfer rolls 13, and may include a vision camera.

In this case, the vision camera photographs the thermochromic pigment of the electrolyte membrane 1 passing between the transfer rolls 13 and transmits the photographed image to the main control unit 30 (hereinafter, referred to as a ‘controller’) such that the controller checks the color of the thermochromic pigment from the photographed image to determine whether the color is normal.

Here, the controller 30 determines malfunction of the temperature control of the transfer rolls when the color of the thermochromic pigment 22 is different from a color appearing within the normal temperature range of the transfer rolls 13, or is the same color as that appearing at a temperature exceeding the upper limit of the setting temperature range of the transfer rolls.

In addition, the controller 30 drives the alarm device 41 to alarm a worker and stops the apparatus when the temperature control of the transfer rolls 13 has malfunctioned.

Needless to say, the apparatus may be driven normally when the normal temperature control of the transfer rolls is determined.

In determining whether the temperature control of the transfer rolls is normal from the image of the vision camera (the color information acquiring unit), a method of extracting, by the controller 30, a color value of the thermochromic pigment from the photographed image, and comparing the extracted color value with a reference value or comparing a color value of the photographed image with a color of a coating area of the thermochromic pigment from an inherently-acquired and stored reference image to determine whether the temperature control has malfunctioned, may be applicable.

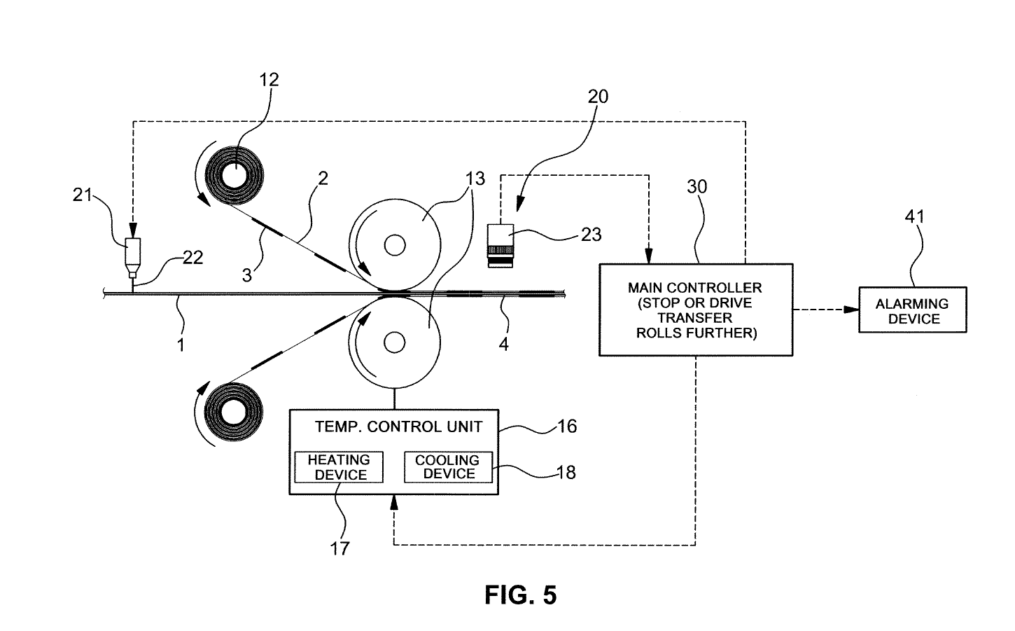

FIG. 5 is a schematic diagram illustrating an apparatus for manufacturing a membrane electrode assembly according to another embodiment of the present invention in which the temperature control unit 16 of the transfer rolls 13 may include a heating device 17 (for example, a heater installed in the transfer roll) and a cooling device 18 to decrease temperature of the transfer rolls by cooling the transfer rolls if necessary.

The cooling device 18 cools the transfer rolls by force when the temperature of the transfer rolls 13 exceeds the setting temperature range and is overheated abnormally such that the controller 30 drives the cooling device to control the temperature of the transfer rolls within the normal temperature range when the overheat state of the transfer rolls is determined from the color change of the thermochromic pigment 22.

In the apparatus for manufacturing a membrane electrode assembly including the cooling device, the controller may drive the cooling device automatically to reduce the temperature of the transfer rolls even when the transfer rolls have overheated temporally, and after that may check the color change of the thermochromic pigment again to drive the apparatus further when the temperature of the transfer rolls are controlled with the normal setting temperature range.

In this embodiment, since the cooling device cools the transfer rolls by force even when the overheat state of the transfer rolls instantly, stopping of the apparatus can be minimized or the apparatus can be driven continuously without a stop.

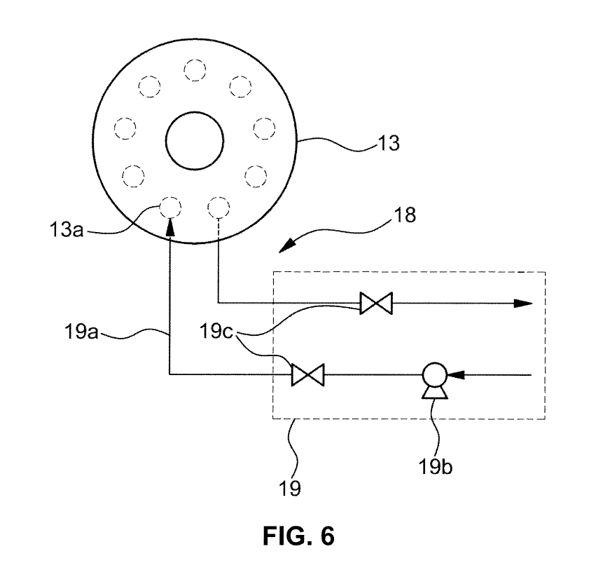

Preferably, the cooling device 18 may be a device to feed a coolant to the transfer rolls 13 to circulate through the same. The cooling device 19 may include a cooling passage 13a provided in the transfer rolls 13 to allow the coolant to flow therethrough and a coolant feeder 19 provided to the cooling passage 13a to feed the coolant selectively. In this case, the coolant feeder 19, as illustrated in FIG. 6, may include a fluid pipe 19a communicating with the cooling passage 13a of the transfer rolls 13, a pumping device 19b provided to pump the coolant to the cooling passage 13a of the transfer rolls 13 via the fluid pipe 19a, and a valve device 19c to switch feeding of the coolant through the fluid pipe 19a.

The controller 30 controls the pumping device 19b and the valve device 19c to feed the coolant to the cooling passage 13a of the transfer rolls 13 selectively.

Preferably, the coolant may be water and in this case the coolant feeding device may be a water supplying device to supply water according to a control signal from the controller. The water supplying device may include a pump as a water pumping device. By doing so, the apparatus for manufacturing a membrane electrode assembly according to the present invention may check whether the temperature control of the transfer rolls is normal from the color change of the thermochromic pigment so that malfunction of the temperature control for the transfer rolls can be promptly detected. Particularly, since driving/stopping of the apparatus (or continuous driving by cooling the transfer rolls when the transfer rolls are overheated) is selectively controlled when the temperature control has malfunctioned, a series of inferior products caused by abnormal temperature control of the transfer rolls can be prevented.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for manufacturing a membrane electrode assembly, comprising:
transfer rolls, the temperature of which is controlled by a temperature control unit, to pass a transfer film on which a polymer electrolyte membrane and electrodes are formed therebetween in order to press the transfer film and to transfer the electrodes onto the polymer electrolyte membrane;
a thermochromic pigment inserting device installed at a front end of the transfer rolls to coat the thermochromic pigment on the polymer electrolyte membrane;
a color information acquiring unit installed at the rear side of the transfer rolls to acquire color change information of the thermochromic pigment; and
a controller to check whether temperature control of the transfer rolls is normal from the color change information of the thermochromic pigment acquired by the color information acquiring unit.

2. The apparatus of claim 1, wherein the thermochromic pigment inserting unit is provided such that the thermochromic pigment is coated at a lateral position of an electrode area on the polymer electrolyte membrane and to coat the thermochromic pigment along the polymer electrolyte membrane in a continuous line form or intermittently by a predetermined interval.

3. The apparatus of claim 1, further comprising an alarm device driven by the controller,
wherein the controller is set to drive the alarm device when the controller determines that the temperature control of the transfer rolls in which the temperature of the transfer rolls exceeds a setting temperature range has malfunctioned from the color change information of the thermochromic pigment.

4. The apparatus of claim 1, wherein the controller is set to stop the apparatus when the temperature control of the transfer rolls in which the temperature of the transfer rolls exceeds a setting temperature range has malfunctioned from the color change information of the thermochromic pigment.

5. The apparatus of claim 1, wherein the color information acquiring unit comprises a vision camera to photograph the thermochromic pigment passing between the transfer rolls and to transmit a photographed image of the thermochromic pigment to the controller, wherein the controller checks a color of the thermochromic pigment from the transmitted image from the vision camera and determines whether the temperature control of the transfer rolls has malfunctioned.

6. The apparatus of claim 3, 4, or 5, wherein the thermochromic pigment comprises a thermochromic pigment color of which changes to a predetermined color at a temperature exceeding an upper limit of the predetermined temperature of the transfer rolls, and the controller determines the malfunctioned temperature control of the transfer rolls by checking whether the color of the thermochromic pigment changes to the predetermined color.

7. The apparatus of claim 3, 4, or 5, wherein the thermochromic pigment comprises a thermochromic pigment color which changes to the predetermined color at a temperature of ‘an upper limit+α’ that a margin ‘α’ is added to an upper limit of the setting temperature range of the transfer rolls, and the controller determines the malfunctioned temperature control of the transfer rolls by checking whether the color of the thermochromic pigment changes to the predetermined color.

8. The apparatus of claim 1, wherein the temperature control unit comprises a cooling device driven by the controller to cool the transfer rolls, and the controller controls the temperature of the transfer rolls within the setting temperature range by driving the cooling device under the acquired color change information of the thermochromic pigment when the transfer rolls are overheated beyond the setting temperature range of the transfer rolls.

9. The apparatus of claim 8, wherein the cooling device comprises:
a cooling passage provided in the transfer rolls to allow a coolant to flow; and
a coolant feeding device driven to feed the coolant to the cooling passage according to a control signal from the controller.
